(19) United States
(12) Patent Application Publication
(10) Pub. No.: US 2026/0178399 A1
(43) Pub. Date: Jun. 25, 2026

(54) METHOD AND APPARATUS TO ACHIEVE TEMPORAL FREEDOM FROM INTERFERENCE FOR SAFE PROCESSES IN MULTI-THREADED PROCESSORS

(71) Applicant: QUALCOMM Incorporated, San Diego, CA (US)

(72) Inventors: Amol UPRETI, Lalitpur (IN); Naresh Kumar SHARMA, Hyderabad (IN); Chidvilas YERRAMSETTI, Mudinepalli (IN)

(21) Appl. No.: 18/991,052

(22) Filed: Dec. 20, 2024

(51) Int. Cl. G06F 9/50

(52) U.S. Cl. CPC G06F 9/5038

(57) ABSTRACT

A method of temporal freedom from interference (FFI) for safe tasks is described. The method includes writing an incoming safe task to a safe task field of a control register. The method also includes determining a safe partition and a non-safe partition of processing elements (PEs). The method further includes determining priorities of currently executed safe tasks in the safe partition and non-safe tasks in a non-safe partition of the PEs. The method also includes preempting a currently executed safe task if a priority of the currently executed safe task is less than a priority of the incoming safe task.

### BACKGROUND

### Field

Aspects of the present disclosure relate to automotive systems, and in particular, to a method and apparatus to achieve temporal freedom from interference (FFI) for safe processes in multi-threaded processors.

### Background

In the automotive industry, vehicles are rated via an automotive safety integrity level (ASIL) rating system. ASIL ratings, ranging from ASIL-A to ASIL-D, categorize the severity of potential hazards and the rigor specified to mitigate the hazards. ASIL-A represents the lowest safety integrity level and is awarded to systems implementing fewer safety measures, while ASIL-D signifies the highest safety integrity level and is awarded to systems implementing more stringent safety protocols. These ratings guide automotive development, validation, and verification processes to increase the likelihood save automotive operation, even in the presence of faults. The ASIL framework encompasses risk assessment, hazard analysis, and the implementation of redundant and diverse safety mechanisms to prevent or mitigate failures.

Vehicle or automotive control systems are typically subjected to more stringent operational requirements. This is because errors in such vehicle or automotive control systems may result in severe injury and death to humans occupying associated vehicles, as well as humans, animals, and property that may collide with such vehicles. Such stringent operational requirements typically deal with system redundancy, greater resistance to electrical and software faults, and improved monitoring of such systems, to name a few. In particular, automotive applications include time critical safety tasks, which require priority access to processor resources. Conventional real-time operating systems (RTOSs) schedule tasks based on priority and/or time-slicing. Unfortunately, conventional RTOSs do not take safety and freedom from interference (FFI) into consideration when scheduling tasks. As a result, a shared resource can be over-utilized by non-critical tasks.

### SUMMARY

A method of temporal freedom from interference (FFI) for safe tasks is described. The method includes writing an incoming safe task to a safe task field of a control register. The method also includes determining a safe partition and a non-safe partition of processing elements (PEs). The method further includes determining priorities of currently executed safe tasks in the safe partition and non-safe tasks in a non-safe partition of the PEs. The method also includes preempting a currently executed safe task if a priority of the currently executed safe task is less than a priority of the incoming safe task.

A non-transitory computer-readable medium having program code recorded thereon for temporal freedom from interference (FFI) of safe tasks is described. The program code is executed by a processor. The non-transitory computer-readable medium includes program code to write an incoming safe task to a safe task field of a control register. The non-transitory computer-readable medium also includes program code to determine a safe partition and a non-safe partition of processing elements (PEs). The non-transitory computer-readable medium further includes program code to determine priorities of currently executed safe tasks in the safe partition and non-safe tasks in a non-safe partition of the PEs. The non-transitory computer-readable medium also includes program code to preempt a currently executed safe task if a priority of the currently executed safe task is less than a priority of the incoming safe task.

This has outlined, broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a block diagram illustrating a system-on-chip (SoC) configured to provide temporal freedom from interference (FFI) for safe processes utilizing partitioned processing elements (PEs), in accordance with various aspects of the present disclosure.

FIG. 2 is a block diagram illustrating temporal freedom from interference (FFI) for safe processes in a multi-threaded processor of a system-on-chip (SoC), in accordance with various aspects of the present disclosure.

FIG. 3 is a block diagram further illustrating temporal freedom from interference (FFI) for safe processes in the multi-threaded processor of the SoC of FIG. 2, in accordance with various aspects of the present disclosure.

FIGS. 4A and 4B are block diagrams further illustrating temporal freedom from interference (FFI) for safe processes utilizing the partitioned processing elements (PEs) of the multi-threaded processor of the system-on-chip (SoC) of FIG. 2, in accordance with various aspects of the present disclosure.

FIG. 5 is a block diagram illustrating a register description to configure temporal freedom from interference (FFI) for safe processes in a multi-threaded processor, in accordance with various aspects of the present disclosure.

FIG. 6 is a boot-up sequence diagram illustrating static allocation of hardware threads (HWTs) to provide temporal freedom from interference (FFI) for safe processes in a multi-threaded processor, in accordance with various aspects of the present disclosure.

FIG. 7 is a sequence diagram illustrating dynamic runtime allocation of hardware threads after system bootup to provide temporal freedom from interference (FFI) for safe processes, in accordance with various aspects of the present disclosure.

FIG. 8 is a flow chart illustrating a process for safe interrupt routing to provide temporal freedom from interference (FFI) for safe processes in a multi-threaded processor, in accordance with various aspects of the present disclosure.

FIG. 9 illustrates a block diagram of an example vehicle system having a temporal freedom from interference (FFI) interface for safe processes in partitioned processing elements (PEs), in accordance with various aspects of the present disclosure.

FIG. 10 is a process flow diagram illustrating a method for temporal freedom from interference (FFI) for safe processes in partitioned processing elements (PEs), according to various aspects of the present disclosure.

FIG. 11 is a block diagram showing an exemplary wireless communications system in which an aspect of the present disclosure may be advantageously employed.

FIG. 12 is a block diagram illustrating a design workstation used for circuit, layout, and logic design of a semiconductor component having partitioned processing elements (PEs), disclosed herein.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

Electronic circuits designed for vehicle or automotive control, or other safety-related applications may be prescribed with more stringent specifications. These stringent specifications are prescribed because faults in automotive control circuits may result in severe injury and death to humans. There are governmental organizations that prescribe the specifications of electronic circuits for automotive control and other safety-related applications. These organizations include the International Organization for Standardization (ISO) and the International Electrotechnical Commission (IEC).

For example, the ISO has prescribed international standard ISO 26262 entitled “Road vehicles—Functional safety,” which provides specifications for functional safety of electrical and/or electronic systems in serial production road vehicles. The IEC has prescribed an international standard IEC 61508 entitled “Functional Safety of Electrical/Electronic/Programmable Electronic Safety-related Systems,” which outlines methods on how to apply, design, deploy and maintain automatic protection systems called safety-related systems. In both ISO 26262 and IEC 61508, their specifications state that certain safety-related systems be continuously monitored during runtime in order to ensure proper operations of the safety-related items.

Automotive applications may execute in a multi-threaded processor that utilizes hardware threads (HWTs) as execution units, in which a scheduler schedules software tasks on the HWTs based on priorities. The scheduler is HW assisted and governed by a control register (e.g., a “BESTWAIT” register). In practice, the BESTWAIT register is programmed by software with a highest priority task that is currently awaiting execution. During operation, if an HWT is executing a task with a lower priority than a waiting task, the lower priority task is preempted, which allows the higher priority task to proceed with execution.

Automotive applications that are executed using a multi-threaded processor are specified to comply with an automotive safety integrity level (ASIL) specification for safety use cases. For example, temporal freedom from interference (FFI) is an ASIL specification for safety use cases. Consequently, the automotive industry specifies compliance with the temporal FFI for automotive applications. Unfortunately, temporal FFI is not achieved by a real-time operating system (RTOS) when a low priority “safety” task/application gets preempted by a higher priority set non-safety application/task. In particular, automotive applications fail to comply with temporal FFI when “safe” and “non-safe” task priorities are combined and there is no mechanism to inform the multi-thread processor through the BESTWAIT register that a safe task should not be preempted by a higher priority non-safe task.

Automotive applications have time critical safety tasks that specify priority access to processor resources. Currently, real-time operating systems (RTOSs) schedule tasks based on priority and/or time-slicing. Unfortunately, these do not take safety and freedom from interference (FFI) into consideration. As a result, a shared resource can be over-utilized by non-critical tasks. For example, a digital signal processor (DSP) hardware device generally contains a BESTWAIT register that routes a software (SW) task to a specific HWT, which is running with a lowest priority task and preempts the lowest priority task. Additionally, a micro-kernel scheduler runs with monotonically increasing priorities, resulting in a preemptive scheduler that handles both safe and non-safe tasks in various process domains (PDs). As a result, a non-safe task with higher priority preempts a safe task with a lower priority in this system.

Various aspects of the present disclosure are directed to hardware (HW) segregation/partitioning for processing elements (PEs) to provide improved performance for safety-critical tasks in an isolated manner. Some implementations of the present disclosure introduce a safety bit in a multi-threaded processor to provide further control of the registers that are configured from software: (1) statically during early bootup for resource allocation; or (2) dynamically when allocating the HWTs to the software tasks. In this implementation, the safety bit helps manage hardware resources for safety-critical and non-safety applications. For example, using BESTWAIT hardware assistance as well as other control registers to separately prioritize the safe and non-safe applications enables compliance with temporal FFI safety critical tasks/automotive use cases (e.g., collision detection and avoidance, emergency braking, and the like).

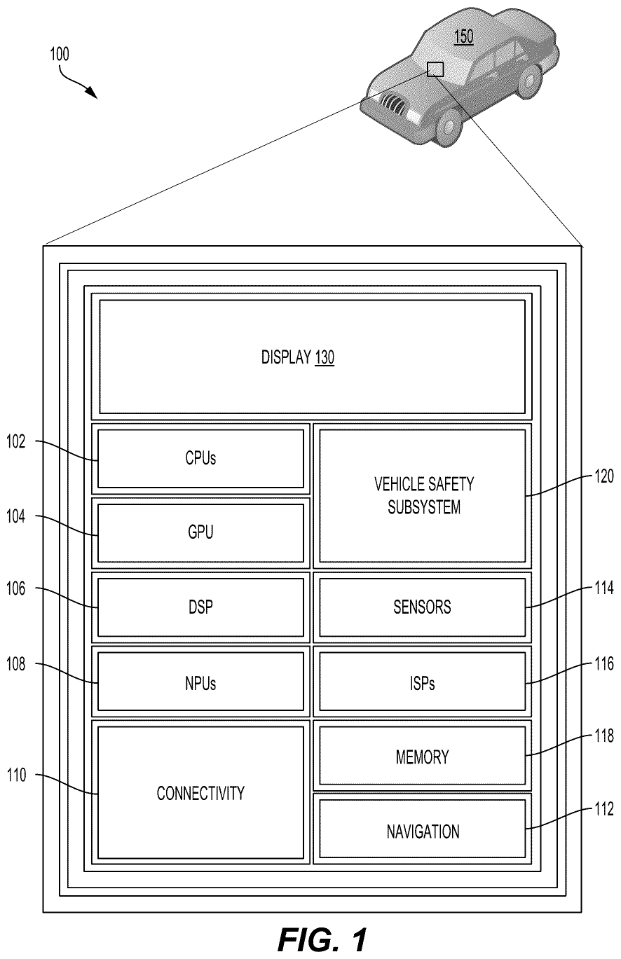

FIG. 1 illustrates an example implementation of temporal freedom from interference (FFI) for safe processes utilizing partitioned processing elements (PEs) during automotive operation using a system-on-chip (SoC) 100 of a vehicle 150. The SoC 100 may include a single processor or multi-core processors (e.g., a central processing unit (CPU) 102), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SoC 100 may also include additional processing blocks configured to perform specific functions, such as the GPU 104, the DSP 106, and a connectivity block 110, which may include sixth generation (6G) cellular network technology, fifth generation (5G) new radio (NR) technology, fourth generation long term evolution (4G LTE) connectivity, unlicensed WIFI connectivity, USB connectivity, Bluetooth® connectivity, and the like. In addition, a multimedia processor (not shown) in combination with a display 130 may, for example, apply a temporal component of a current traffic state to select a vehicle safety action, according to the display 130 illustrating a view of a vehicle. In some aspects, the NPU 108 may be implemented in the CPU 102, DSP 106, and/or GPU 104. The SoC 100 may further include a sensor processor 114, image signal processors (ISPs) 116, and/or navigation 112, which may, for instance, include a global positioning system.

The SoC 100 may be based on an Advanced Risk Machine (ARM) instruction set or the like. Each processor core of a multi-core CPU 102 may be a reduced instruction set computing (RISC) machine, RISC-V, an advanced RISC machine (ARM), a microprocessor, or any reduced instruction set computing (RISC) architecture. The NPU 108 may be based on an ARM instruction set. In another aspect of the present disclosure, the SoC 100 may be a server computer in communication with the vehicle 150. In this arrangement, the vehicle 150 may include a processor and other features of the SoC 100. In this aspect of the present disclosure, instructions loaded into a vehicle safety subsystem 120 of the vehicle 150 may include program code to ensure temporal FFI for safe processes during automotive operation.

As shown in FIG. 1, the SoC 100 may be used in an automotive control system or other type of safety-related system. The SoC 100 may include a set of subsystems (not shown) to perform various operations in accordance with the design specification for the SoC 100. For example, in the case of automotive control, the set of subsystems may include semiautonomous or autonomous driving subsystems (e.g., Advanced Driver Assistance Systems (ADAS)), such as forward collision warning (FCW), lane departure warning (LWA), blind spot detection (BSD) subsystems (e.g., ADAS level “0” subsystems); adaptive cruise control (ACC) and lane keep assist (LKA) subsystems (e.g., ADAS level “1” subsystems); ACC with lane keeping and traffic jam assist subsystems (e.g., ADAS level “2” subsystems); highway autopilot and traffic jam pilot subsystems (e.g., ADAS level “3” subsystems); full highway autopilot and full urban autopilot subsystems (e.g., ADAS level “4” subsystems); and robo-taxi/shuttles and autonomous delivery fleets subsystems (e.g., ADAS level “5” subsystems).

In automotive applications, such as advanced driver assistance systems (ADASs) or fully autonomous driving (e.g., safety critical automotive applications), providing temporal FFI presents a significant problem. For example, automotive applications include time critical safety tasks, which specify priority access to processor resources. Currently, real-time operating systems (RTOSs) schedule tasks based on priority and/or time-slicing. Unfortunately, priority/time-slicing scheduling does not take safety and FFI into consideration. As a result, a shared resource can be over-utilized by non-critical tasks.

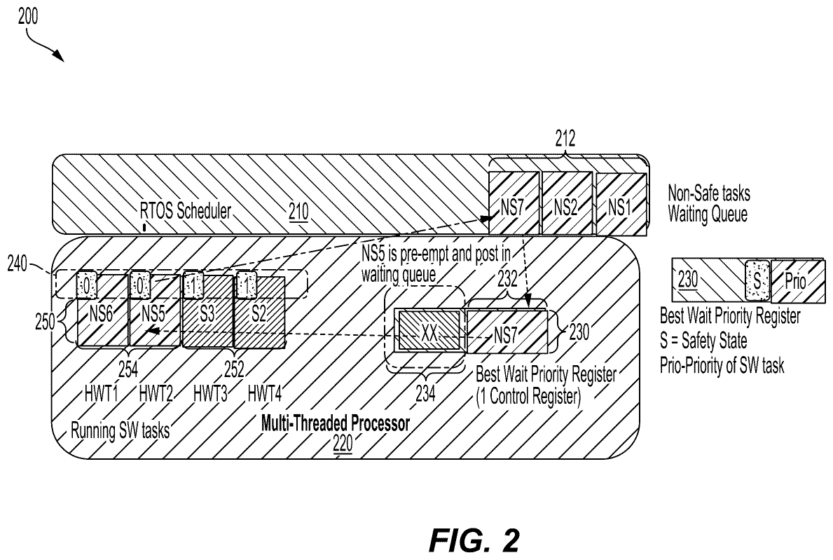

For example, digital signal processor (DSP) hardware generally contains a BESTWAIT register that routes a software task to a specific HWT, which is running with a lowest priority task and preempts the lowest priority task. Additionally, a micro-kernel scheduler running with monotonically increasing priorities, results in a preemptive scheduler that handles both safe and non-safe tasks in various process domains (PDs). As a result, a non-safe task with higher priority preempts a safe task with a lower priority in this system. This priority-based scheduling leads to delays in the execution of safety-critical tasks due to the resource demands of non-safe tasks. A multi-threaded processor configured to provide temporal FFI for safe processes during automotive operation is illustrated, for example, in FIG. 2.

FIG. 2 is a block diagram illustrating temporal freedom from interference (FFI) for safe processes in a multi-threaded processor 220 of a system-on-chip (SoC) 200, in accordance with various aspects of the present disclosure. As shown in FIG. 2, a real-time operating system (RTOS) scheduler 210 schedules tasks for execution through allocated hardware threads (e.g., processing elements (PEs)) of a multi-threaded processor 220 (e.g., a digital signal processor (DSP)). According to various aspects of the present disclosure, safety/critical tasks are separated from non-safe tasks regardless of non-safe task priorities.

As shown in FIG. 2, the multi-threaded processor 220 utilizes partitioned processing elements (PEs) 250, including a first hardware thread (HWT1), a second hardware thread (HWT2), a third hardware thread (HWT3), and a fourth hardware thread (HWT4) for processing received software (SW) tasks. In this example, an HWT identification (ID) register 240 (e.g., a PE ID register) of each of the partitioned PEs 250 (e.g., HWT1, HWT2, HWT3, HWT4) identifies whether the hardware thread is allocated for safe tasks or non-safe tasks. For example, the HWT3 and the HWT4 hardware threads are allocated for safe tasks by asserting (e.g., setting to one (1)) the HWT ID register 240 to provide a safe partition 252 of the partitioned PEs 250. Conversely, the HWT1 and the HWT2 hardware threads are allocated for non-safe tasks by de-asserting (e.g., setting to zero (0)) the HWT ID register 240 to provide a non-safe partition 254 of the partitioned PEs 250.

FIG. 2 illustrates scheduling of non-safe tasks on a subsystem (e.g., the partitioned PEs 250), such as hardware threads (HWTs) of the multi-threaded processor 220. For example, a non-safe (NS) task with n priority (NSn) is allocated to a HWT (e.g., HWT allocation=2). Similarly, a safe (S) task with m priority (Sm) is allocated to the same HWT (e.g., HWT allocation=2). In this example, the NSn task has a higher priority the Sm task when n is greater than m (e.g., n>m: higher number means higher priority).

As shown in FIG. 2, a high priority non-safe task NS7 (e.g., incoming non-safe task) is received by the RTOS scheduler 210 and stored in a non-safe tasks waiting queue 212 along with low priority non-safe tasks NS2 and NS1. Additionally, software tasks are running on the HWT1, HWT2, HWT3, and HWT4 hardware threads of the multi-threaded processor 220. In this example, a safe task S3 is running in HWT3 (e.g., a currently executed safe task) and a safe task S2 is running in HWT4 hardware thread because the HWT3 and the HWT4 hardware threads are allocated for safe tasks (a safe PE or a non-safe PE). Conversely, a non-safe task NS6 runs in HWT1 hardware thread and a non-safe task NS5 runs in HWT2 hardware thread because the HWT1 and the HWT2 hardware threads are allocated for non-safe tasks.

According to various aspects of the present disclosure, a BESTWAIT priority register 230 separates safe tasks from non-safe tasks using a non-safe task field 232 and a safe task field 234, which are based on a safety state bit S and a priority field of the software (SW) task (Prio). During operation, the received, high priority non-safe task NS7 is written to the non-safe task field 232, while the safe task field 234 is empty. Once written, this process involves determining priorities of currently executed non-safe tasks (e.g., the non-safe task NS5 running in the HWT2 hardware thread and the non-safe task NS6 running in the HWT1 hardware thread). In this example, the non-safe task NS7 preempts the non-safe task NS5 running in the HWT2 hardware thread, which is returned to the non-safe tasks waiting queue 212 because the non-safe task NS5 is the lowest priority non-safe task.

According to various aspects of the present disclosure, the safe tasks S2 and S3 are allowed to continue execution because the safe task field 234 of the BESTWAIT priority register 230 is empty. In particular, although the non-safe task NS7 has a higher priority than each of the safe tasks S2 and S3, the non-safe task NS7 does not preempt the safe tasks S2 and S3 because the non-safe task NS7 is limited to execution in the HWT1 and HWT2 hardware threads. This limitation exists because the HWT1 and HWT2 hardware threads are allocated for non-safe tasks due to de-asserting (e.g., setting to zero (0)) of the HWT ID register 240. Consequently, this solution avoids delays in the execution of safety-critical tasks (e.g., safe tasks S2 and S3) due to the resource demands of non-safe tasks (e.g., non-safe task NS7).

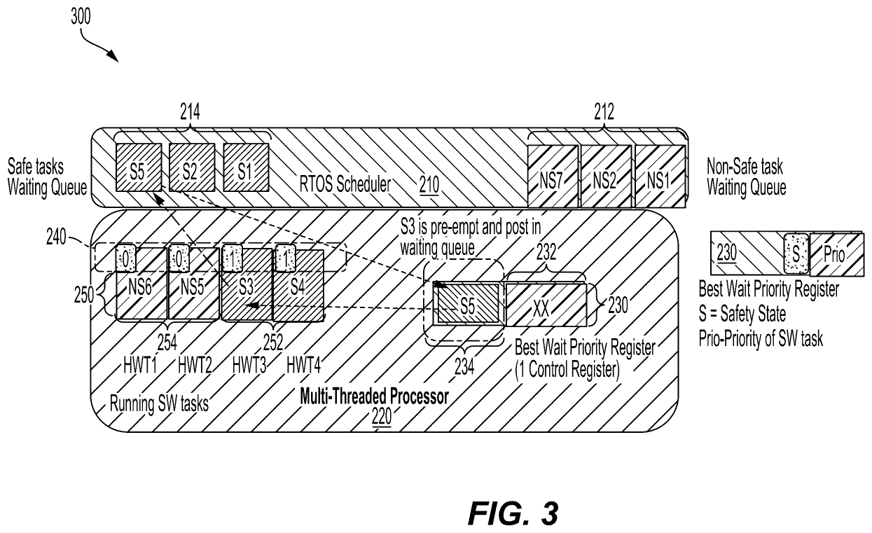

FIG. 3 is a block diagram 300 further illustrating temporal freedom from interference (FFI) for safe processes in the multi-threaded processor 220 of the SoC 200 of FIG. 2, in accordance with various aspects of the present disclosure. FIG. 3 illustrates the RTOS scheduler 210 scheduling in response to receiving a safe task S5 for execution through the safe task allocated hardware threads (e.g., HWT3 or HWT4) of the partitioned PEs 250 of the multi-threaded processor 220. According to various aspects of the present disclosure, safety/critical tasks are separated from non-safe tasks regardless of an associated task priority.

As shown in FIG. 3, a safe task S5 (e.g., an incoming safe task) is received by the RTOS scheduler 210 and stored in a safe tasks waiting queue 214 along with safe tasks S2 and S1. Additionally, non-safe tasks NS7, NS2, and NS1 are stored in the non-safe tasks waiting queue 212. In this example, a safe task S3 (e.g., a lowest priority safe task) is running in the HWT3 hardware thread, a safe task S4 is running in the HWT4 hardware thread, a non-safe task NS6 runs in the HWT1 hardware thread, and a non-safe task NS5 runs in the HWT2 hardware thread. During operation, the received, safe task S5 is written to the safe task field 234 of the BESTWAIT priority register 230, while the non-safe task field 232 is empty. Once written to the safe task field 234, this operation involves determining priorities of the currently executed safe tasks (e.g., S3 running in the HWT3 hardware thread and the safe task S4 running in the HWT4 hardware thread). In this example, the safe task S5 preempts the safe task S3 running in the HWT3 hardware thread because the safe task S3 is the lowest priority safe task. Additionally, the safe task S3 is returned to the safe tasks waiting queue 214.

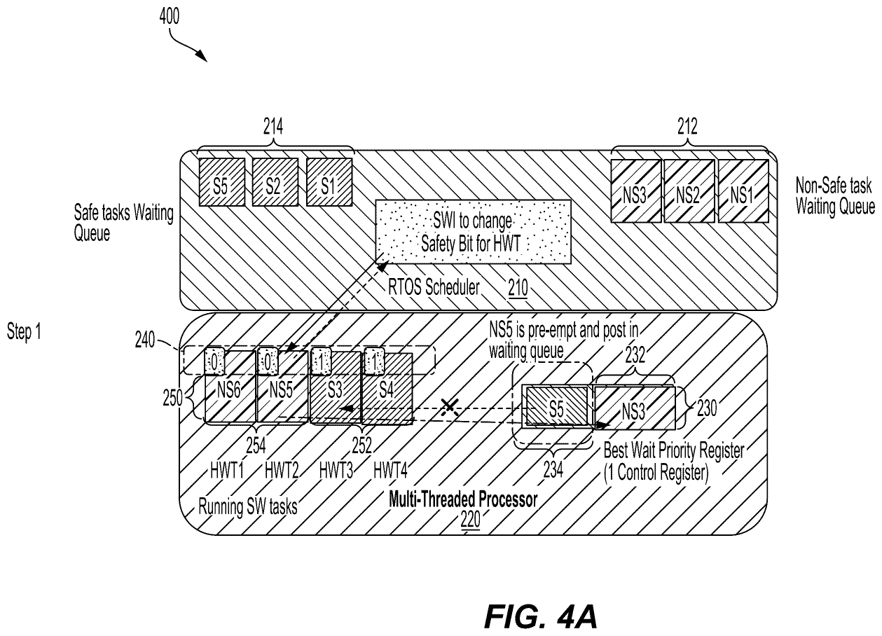

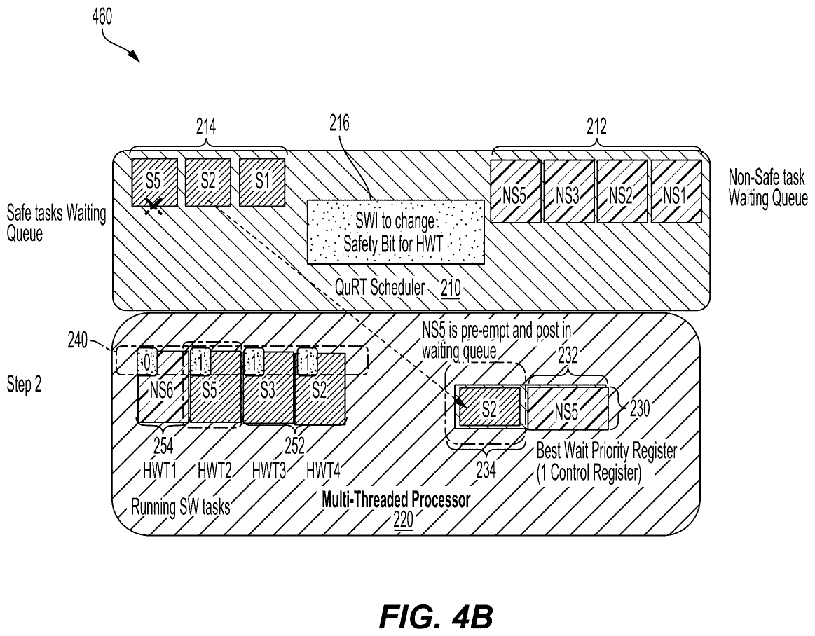

FIGS. 4A and 4B are block diagrams further illustrating temporal freedom from interference (FFI) for safe processes utilizing the partitioned PEs 250 of the multi-threaded processor 220 of the SoC 200 of FIG. 2, in accordance with various aspects of the present disclosure. FIG. 4A illustrates a first step 400 for scheduling a mixed criticality task, and FIG. 4B illustrates a second step 460 for scheduling a mixed criticality task using dynamic programming, according to various aspects of the present disclosure.

The first step 400 of FIG. 4A illustrates the RTOS scheduler 210 scheduling in response to concurrently receiving a safe task S5 and a non-safe task NS3. As noted, execution of the safe task S5 is performed through the safe task allocated hardware threads (e.g., HWT3 or HWT4) of the partitioned PEs 250 of the multi-threaded processor 220. Additionally, execution of the non-safe task NS3 is performed through the non-safe task allocated hardware threads (e.g., HWT1 or HWT2) of the partitioned PEs 250 of the multi-threaded processor 220. According to various aspects of the present disclosure, safety/critical tasks are separated from non-safe tasks regardless of an associated task priority.

As shown in FIG. 4A, the safe task S5 and the non-safe task NS3 are received by the RTOS scheduler 210. The safe task S5 is stored in the safe tasks waiting queue 214 along with safe tasks S2 and S1. Additionally, the non-safe task NS3 is stored in the non-safe tasks waiting queue 212 along with non-safe tasks NS2 and NS1. In this example, the safe task S3 is running in the HWT3 hardware thread, the safe task S4 is running in the HWT4 hardware thread, while the non-safe task NS6 runs in the HWT1 hardware thread, and the non-safe task NS5 runs in the HWT2 hardware thread. During operation, the received, safe task S5 is written to the safe task field 234 of the BESTWAIT priority register 230, and the non-safe task NS3 is written to the non-safe task field 232. Once written to the safe task field 234, rather than preempting the safe task S3 running in the HWT2 hardware thread during the first step, the non-safe task NS5 is preempted by the safe task S5, as further illustrated in FIG. 4B.

FIG. 4B illustrates the second step 460 for scheduling of mixed criticality tasks using dynamic programming, according to various aspects of the present disclosure. As shown in FIG. 4B, a software interface (SWI) 216 of the RTOS scheduler 210 is utilized to convert the HWT2 hardware thread from a non-safe task allocation to a safe task allocation by asserting (e.g., setting to one (1)) the HWT ID register 240. Following the conversion, the safe task S5 preempts the non-safe task NS5 running in the HWT2 hardware thread, which is returned to the non-safe tasks waiting queue 212 and written to the non-safe task field 232 of the BESTWAIT priority register 230. Additionally, the safe task S5 is removed from the safe tasks waiting queue 214, and the safe task S2 is written to the safe task field 234 of the BESTWAIT priority register 230.

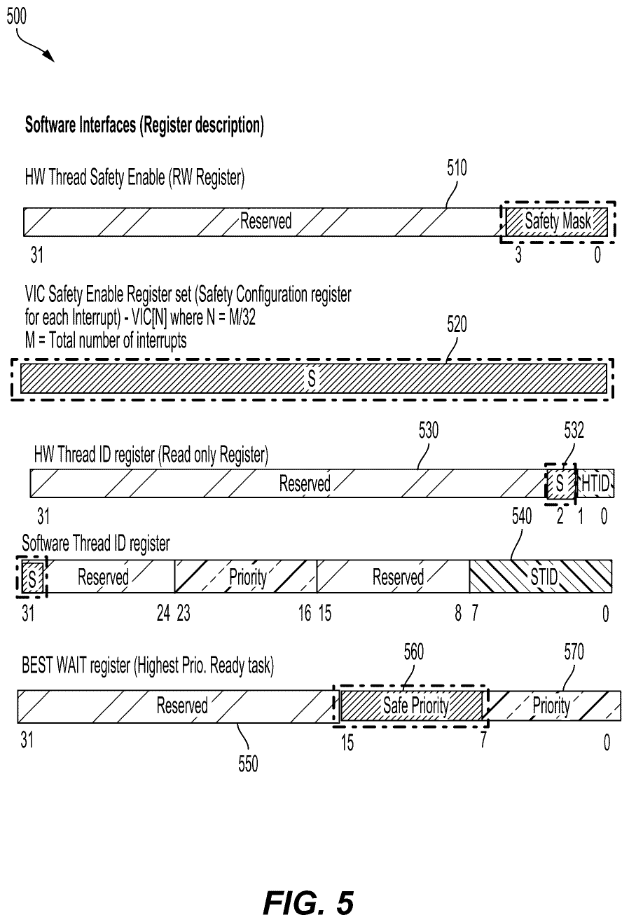

FIG. 5 is a block diagram illustrating a register description to configure temporal freedom from interference (FFI) for safe processes in a multi-threaded processor, in accordance with various aspects of the present disclosure. FIG. 5 illustrates a software interface 500 according to various register descriptions. A first register is a hardware thread (HWT) safety enable register 510, which is configured as a read/write (RW) register. In this example, the HWT safety enable register 510 includes a safe mask field [3:0] and a reserved field [31:4]. In this example, each bit of the safe mask field marks a corresponding HWT as safe by setting a safety bit 532 in an HWT identification (ID) register 530 as one (1). In this example, a one (1) indicates an execution unit (or processing element (PE)) is marked as safe, and a zero (0) indicates an execution unit (or PE) is marked as non-safe.

Additionally, the software interface 500 includes a vector interrupt controller (VIC) safety enable register 520, which operates as a safety configuration register of each interrupt (e.g., VIC[N], where N=M/32 and M=total number of interrupts). In this example, each bit in the VIC safety enable register 520 that is set (e.g., −=1) marks a corresponding interrupt as safe. For example, a one (1) indicates the corresponding interrupt is safe, and a zero (0) indicates the corresponding interrupt is non-safe.

FIG. 5 further illustrates the HWT ID register 530 that includes an HWT ID (HTID) field [1:0] and the safety bit 532 field. In this example, a one (1) indicates the execution unit (or processing element (PE)) is running a safety critical task, and a zero (0) indicates the execution unit (or PE) is running a non-safe task. A software thread ID (STID) register 540 forms part of the software interface 500 and includes an STID field 542 to enable writing of a software task priority in the SW thread ID register 540, which is used by HW to compare against the BESTWAIT register 550. Additionally, the software interface 500 includes the BESTWAIT register 550, which stores the highest priority ready task. In this example, the BESTWAIT register 550 includes a priority field 570 [7:0], a safe priority field 560 [15:8], and a reserved field [31:16].

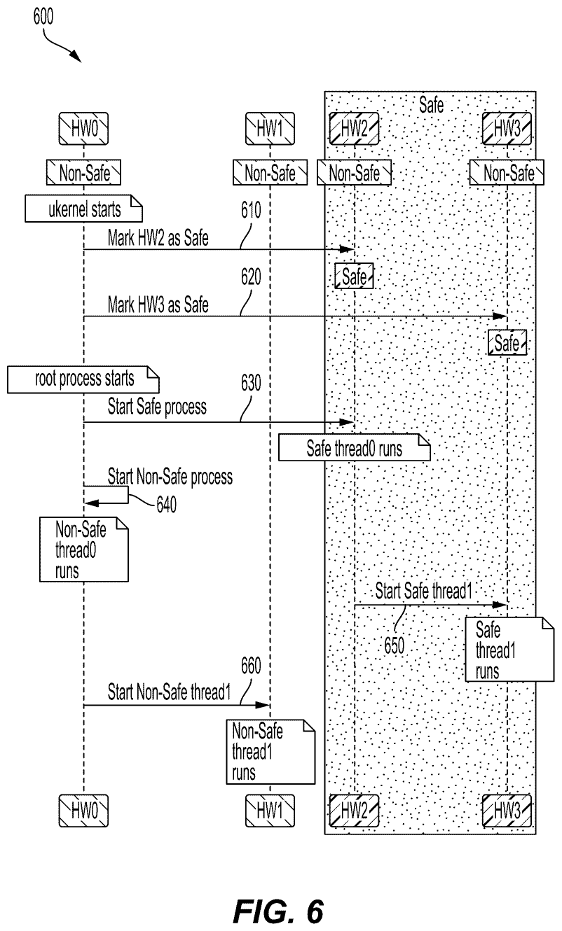

FIG. 6 is a boot-up sequence diagram 600 illustrating static allocation of hardware threads (HWTs) to provide temporal freedom from interference (FFI) for safe processes in a multi-threaded processor, in accordance with various aspects of the present disclosure. As shown in FIG. 6, processing elements (e.g., hardware HW0, HW1, HW2, and HW3) are initially allocated to execution of non-safe software (SW) threads. At step 610, a micro-kernel (ukernal) starts and marks hardware HW2 as safe by setting a safety bit 532 of the HWT ID register 530 to one (1), as shown in FIG. 5. At step 620, the ukernal marks hardware HW3 as safe by setting a safety bit 532 of the HWT ID register 530 to one (1), according to static allocation of hardware threads.

As further illustrated in FIG. 6, at step 630, a root process starts and performs a safe start process to run a safe thread (thread0) on the safe hardware HW2. At step 640, a safe start process runs a non-safe thread (thread0) on the non-safe hardware HW0. At step 650, a safe start process runs a safe thread (thread1) on the safe hardware HW3. At step 660, a safe start process runs a non-safe thread (thread1) on the non-safe hardware HW1 to complete the static allocation of hardware threads.

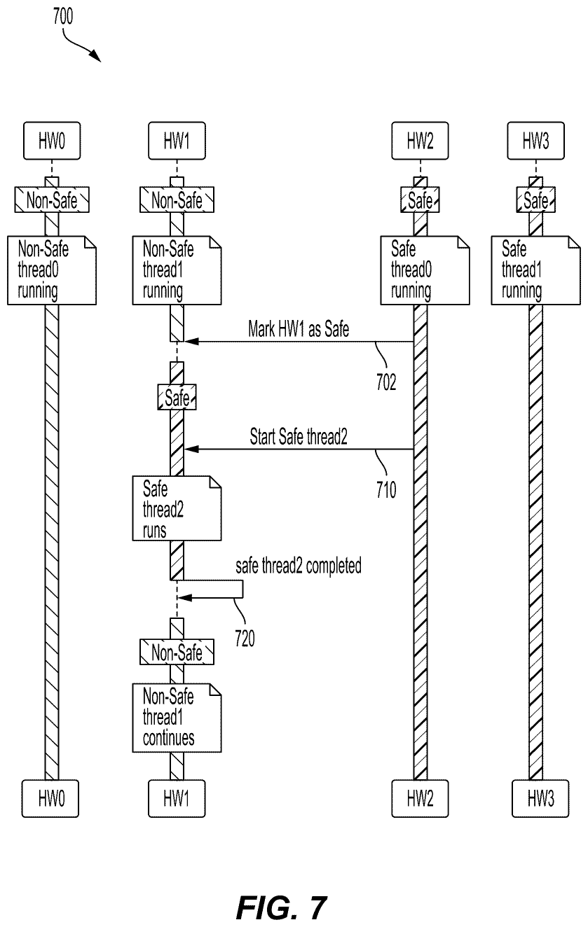

FIG. 7 is a sequence diagram 700 illustrating dynamic runtime allocation of hardware threads (HWTs) after system bootup to provide temporal freedom from interference (FFI) for safe processes, in accordance with various aspects of the present disclosure. As shown in FIG. 7, non-safe hardware HW0 and non-safe hardware HW1 are initially allocated non-safe tasks, and safe hardware HW2 and safe hardware HW3 are initially allocated to execution of safe tasks (e.g., software (SW) threads). For example, the non-safe hardware HW0 runs a non-safe thread0, and the non-safe hardware HW1 runs a non-safe thread1. Similarly, the safe hardware HW2 runs a safe thread0, and the safe hardware HW3 runs a safe thread1.

At step 702, the non-safe hardware HW1 converted to a safe hardware HW1 by setting a safety bit 532 of the HWT ID register 530 to one (1), as shown in FIG. 5. At step 710, a safe start process runs a safe thread (thread2) on the converted safe hardware HW1. That is, the safe thread2 (e.g., a converted safe PE) runs on the converted safe hardware HW1. At step 720, the safe thread2 completes and the safe hardware HW1 is dynamically converted back to a non-safe hardware HW1, for example, by setting the safety bit 532 of the HWT ID register 530 to zero (0). Once converted, the non-safe thread1 continues executing on the non-safe hardware HW1.

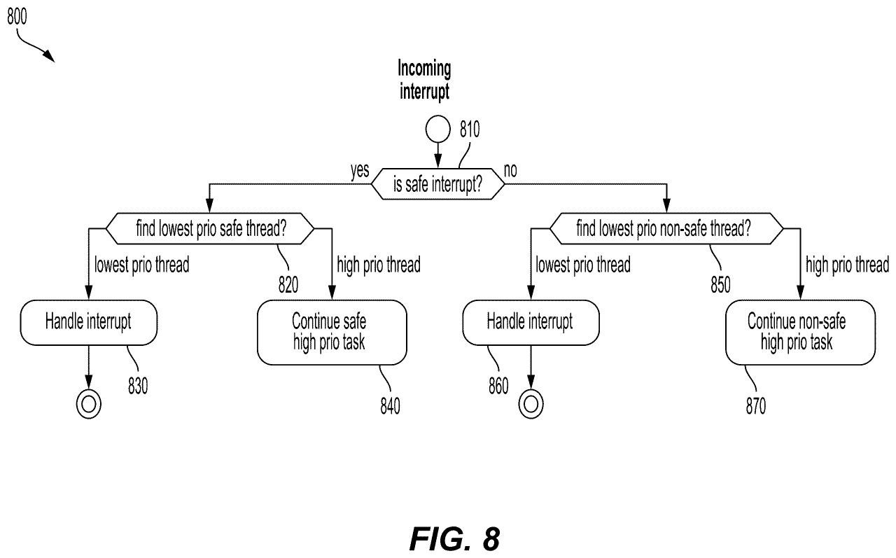

FIG. 8 is a flow chart illustrating a process for safe interrupt routing to provide temporal freedom from interference (FFI) for safe processes in a multi-threaded processor, in accordance with various aspects of the present disclosure. A process 800 begins at block 810, in which it is determined whether an incoming interrupt is a safe interrupt. For example, a vector interrupt controller (VIC) safety enable register (see FIG. 5) associated with the incoming interrupt is queried to determine whether the incoming interrupt is a safety interrupt.

As shown in FIG. 8, when the incoming interrupt is identified as a safe interrupt, at block 820, a lowest priority safe hardware thread (HWT) is identified to handle the safe interrupt at block 830. Additionally, execution of a safe high priority task continues at block 840. Otherwise, the incoming interrupt is identified as a non-safe interrupt at block 810. When the incoming interrupt is identified as a non-safe interrupt, at block 850, a lowest priority non-safe thread is identified to handle the non-safe interrupt at block 860. Additionally, execution of a non-safe high priority task continues at block 870. As shown in FIG. 8, interrupts/exceptions are routed to assigned safe hardware threads (HWTs) for safety applications, and non-safe exceptions/interrupts do not preempt these safe tasks.

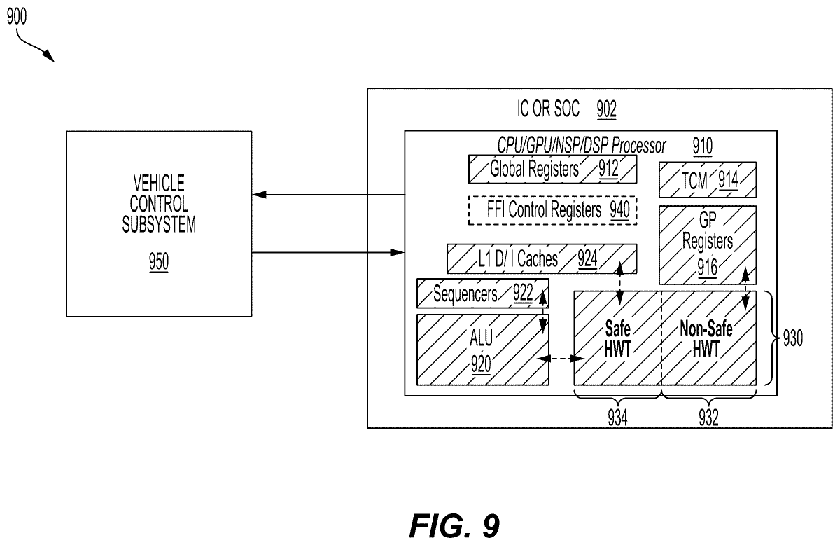

FIG. 9 illustrates a block diagram of an example vehicle system 900 having a temporal freedom from interference (FFI) interface for safe processes in partitioned processing elements (PEs), in accordance with various aspects of the present disclosure. In this example, the vehicle system 900 pertains to an automotive system, but it shall be understood that other types of systems may employ a temporal FFI interface, as described.

The vehicle system 900 includes an integrated circuit (IC) 902, which may be configured as a system-on-chip (SoC). The IC 902 includes a set of one or more central processing unit (CPU)/graphics processing unit (GPU)/neural signal processor (NSP)/digital signal processor (DSP), which are collectively referred to as processors 910. The processors 910 control operation of a vehicle control subsystem 950, global registers 912, tightly coupled memory (TCM) 914, and general purpose (GP) registers 916. Additionally, the processors 910 utilize an arithmetic logic unit (ALU) 920 in combination with sequencers 922, as well as level-one (L1) data/instruction (D/I) cache memory 924.

According to various aspects of the present disclosure, processing elements (PEs) 930 are partitioned into non-safe hardware threads (HWTs) 932 (e.g., non-safe PEs) and safe HWTs 934 (e.g., safe PEs) utilizing a temporal freedom from interference (FFI) interface. In this implementation, the temporal FFI interface is enabled according to FFI control registers 940 configured, for example, according to a safety profile specified by the software interface 500 and register descriptions shown, for example, in FIG. 5.

As shown in FIG. 9, the vehicle control subsystem 950 utilizes automotive applications having time critical safety tasks, specifying priority access to processor resources. Accordingly, in various aspects of the present disclosure, the IC 902 utilizes hardware segregation/partitioning of the PEs 930 to enhance performance of safety-critical tasks of the vehicle control subsystem 950 in an isolated manner for achieving the temporal FFI. For example, these safety critical tasks/automotive use cases for FFI include: (1) collision detection and avoidance; and (2) emergency braking.

Additionally, the hardware segregation/partitioning of the PEs 930 supports mixed criticality application usage, such as sharing resources between autonomous driving applications and in-vehicle infotainment (IVI) applications. For example, in gaming applications, boosting the performance of specific processes is important (e.g., physics simulations). The hardware segregation/partitioning of the PEs 930 further boosts the performance of single threaded workloads by reserving the hardware threads (HWTs)/core for particular use cases. In extended reality (XR) applications, customers specify specific HWTs to be used for sensors processes. In some implementations, the HWT allocation is extended to specific, critical processes.

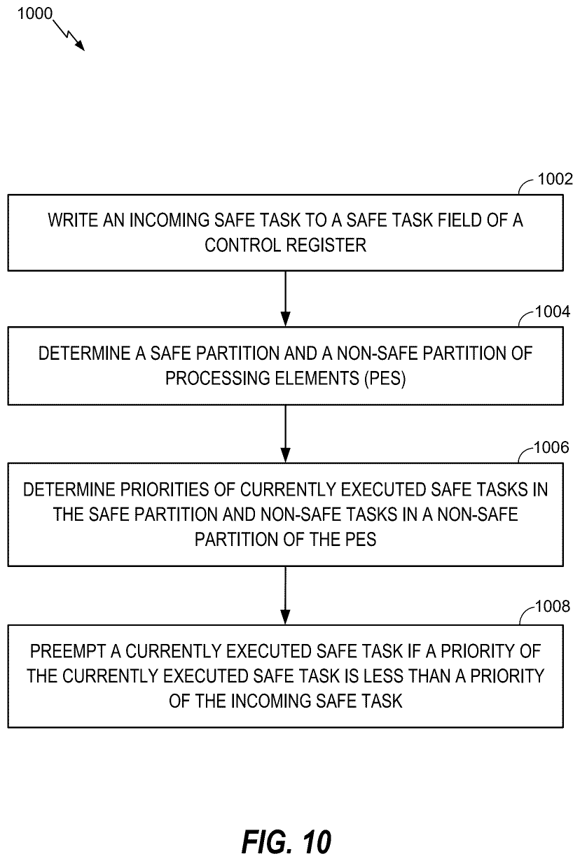

The vehicle control subsystem 950 may include such components as a cruise control subsystem, a forward collision warning (FCW) subsystem, a lane departure warning (LDW) subsystem, a blind spot detection (BSD) warning subsystem, an adaptive cruise control (ACC) subsystem, a lane keep assist (LKA) subsystem, an ACC with lane keeping subsystem, a traffic jam assist subsystem, a full highway autopilot subsystem, a full urban autopilot subsystem, a robo-taxi/shuttle subsystem, an autonomous delivery fleet subsystem, or another like vehicle subsystem. A process for operation of the partitioned PEs 930 is shown, for example, in FIG. 10.

FIG. 10 is a process flow diagram illustrating a method 1000 for temporal freedom from interference (FFI) for safe processes in partitioned processing elements (PEs), according to various aspects of the present disclosure. The method 1000 begins at block 1002, in which an incoming safe task is written to a safe task field of a control register. For example, as shown in FIG. 3, a safe task S5 is received by the RTOS scheduler 210 and stored in a safe tasks waiting queue 214 along with safe tasks S2 and S1. During operation, the received, safe task S5 is written to the safe task field 234 of the BESTWAIT priority register 230, while the non-safe task field 232 is empty.

At block 1004, a safe partition and a non-safe partition of processing elements (PEs) is determined. For example, as shown in FIG. 2, the multi-threaded processor 220 utilizes partitioned PEs 250, including HWT1, HWT2, HWT3, and HWT4 for processing received SW tasks. In this example, an HWT ID register 240 of each of the partitioned PEs 250 identifies whether the hardware thread is allocated for safe tasks or non-safe tasks. For example, the HWT3 and the HWT4 hardware threads are allocated for safe tasks by asserting (e.g., setting to one (1)) the HWT ID register 240 to provide a safe partition 252 of the partitioned PEs 250. Conversely, the HWT1 and the HWT2 hardware threads are allocated for non-safe tasks by de-asserting (e.g., setting to zero (0)) the HWT ID register 240 to provide a non-safe partition 254 of the partitioned PEs 250.

At block 1006, priorities of currently executed safe tasks in the safe partition and non-safe tasks in a non-safe partition of the PEs are determined. For example, as shown in FIG. 2, once written to the safe task field 234, this operation involves determining priorities of the currently executed safe tasks (e.g., S3 running in the HWT3 hardware thread and the safe task S4 running in the HWT4 hardware thread). In this example, the safe task S5 preempts the safe task S3 running in the HWT3 hardware thread because the safe task S3 is the lowest priority safe task. Additionally, the safe task S3 is returned to the safe tasks waiting queue 214.

At block 1008, a currently executed safe task is preempted if a priority of the currently executed safe task is less than a priority of the incoming safe task. For example, as shown in FIG. 4A, the safe task S5 and the non-safe task NS3 are received by the RTOS scheduler 210. In this example, the safe task S3 is running in the HWT3 hardware thread, the safe task S4 is running in the HWT4 hardware thread, while the non-safe task NS6 runs in the HWT1 hardware thread, and the non-safe task NS5 runs in the HWT2 hardware thread. During operation, the received, safe task S5 is written to the safe task field 234 of the BESTWAIT priority register 230, and the non-safe task NS3 is written to the non-safe task field 232. Once written to the safe task field 234, rather than preempting the safe task S3 running in the HWT2 hardware thread during the first step, the non-safe task NS5 is preempted by the safe task S5, as further illustrated in FIG. 4B.

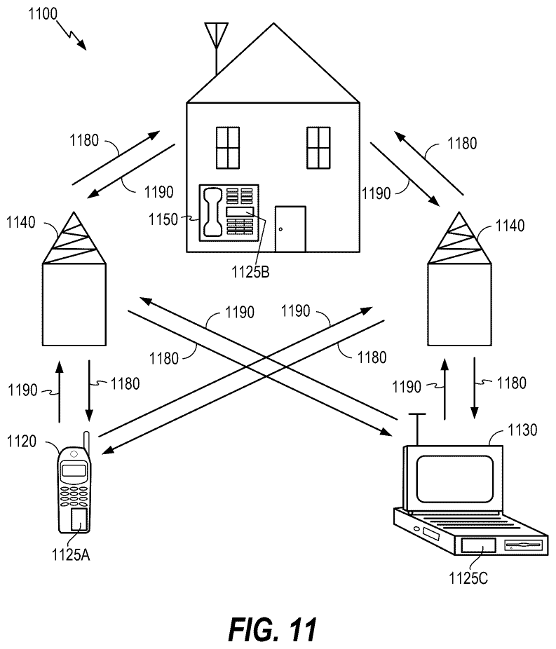

FIG. 11 is a block diagram showing an exemplary wireless communications system 1100 in which an aspect of the present disclosure may be advantageously employed. For purposes of illustration, FIG. 11 shows three remote units 1120, 1130, and 1150 and two base stations 1140. It will be recognized that wireless communications systems may have many more remote units and base stations. Remote units 1120, 1130, and 1150 include integrated circuit (IC) devices 1125A, 1125C, and 1125B that include the disclosed partitioned processing elements (PEs). It will be recognized that other devices may also include the disclosed partitioned PEs, such as the base stations 1140, switching devices, and network equipment. FIG. 11 shows forward link signals 1180 from the base stations 1140 to the remote units 1120, 1130, and 1150, and reverse link signals 1190 from the remote units 1120, 1130, and 1150 to the base stations 1140.

In FIG. 11, remote unit 1120 is shown as a mobile telephone, remote unit 1130 is shown as a portable computer, and remote unit 1150 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a communications device, personal digital assistant (PDA), a fixed location data unit, such as meter reading equipment, or other device that stores or retrieves data or computer instructions, or combinations thereof. Although FIG. 11 illustrates remote units according to the aspects of the present disclosure, the present disclosure is not limited to these exemplary illustrated units. Aspects of the present disclosure may be suitably employed in many devices, which include the disclosed partitioned PEs.

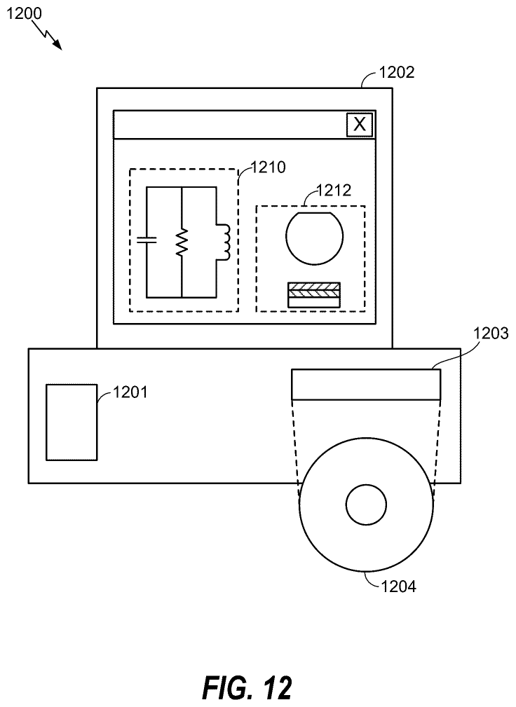

FIG. 12 is a block diagram illustrating a design workstation used for circuit, layout, and logic design of a semiconductor component, such as the partitioned PEs disclosed above. A design workstation 1200 includes a hard disk 1201 containing operating system software, support files, and design software such as Cadence or OrCAD. The design workstation 1200 also includes a display 1202 to facilitate design of a circuit 1210 or an integrated circuit (IC) component 1212 such as a system-on-chip (SoC) having partitioned PEs, as disclosed above. A storage medium 1204 is provided for tangibly storing the design of the circuit 1210 (e.g., the partitioned PEs). The design of the circuit 1210 may be stored on the storage medium 1204 in a file format such as GDSII or GERBER. The storage medium 1204 may be a compact disc read-only memory (CD-ROM), digital versatile disc (DVD), hard disk, flash memory, or another appropriate device. Furthermore, the design workstation 1200 includes a drive apparatus 1203 for accepting input from or writing output to the storage medium 1204.

Data recorded on the storage medium 1204 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 1204 facilitates the design of the circuit 1210 by decreasing the number of processes for designing semiconductor wafers.

Implementation examples are described in the following numbered clauses:
1. A method of temporal freedom from interference (FFI) for safe tasks, the method comprising:
writing an incoming safe task to a safe task field of a control register;
determining a safe partition and a non-safe partition of processing elements (PEs);
determining priorities of currently executed safe tasks in the safe partition and non-safe tasks in a non-safe partition of the PEs; and
preempting a currently executed safe task if a priority of the currently executed safe task is less than a priority of the incoming safe task.
2. The method of clause 1, in which preempting comprises:
selecting a currently executed safe task having a priority less than the priority of the incoming safe task;
posting the currently executed safe task in a safe tasks waiting queue of a real-time operating system (RTOS) scheduler to provide an available, safe PE; and
executing the incoming safe task in the available, safe PE.
3. The method of any of clauses 1 or 2, in which preempting comprises:
selecting a currently executed non-safe task having a lowest priority;
posting the currently executed non-safe task in a non-safe tasks waiting queue of a real-time operating system (RTOS) scheduler to provide an available non-safe PE;
converting the non-safe PE to a converted safe PE; and
executing the incoming safe task in the converted safe PE.
4. The method of clause 3, in which converting comprises:
determining a PE identification (ID) register associated with the non-safe task PE; and
asserting a safety bit of the PE ID register.
5. The method of any of clauses 1-4, in which preempting comprises:
identifying a lowest priority safe task executed in the safe partition of the PEs; and
preempting the lowest priority safe task with the incoming safe task.
6. The method of clause 5, in which preempting the lowest priority safe task comprises:
posting the lowest priority safe task in a safe tasks waiting queue of a real-time operating system (RTOS) scheduler to provide an available, safe PE; and
executing the incoming safe task in the available, safe PE.
7. The method of any of clauses 1-6, further comprising:
writing an incoming non-safe task to a non-safe task field of the control register;
determining priorities of currently executed non-safe tasks in the non-safe partition of the PEs; and
preempting a currently executed non-safe task if a priority of the currently executed non-safe task is less than a priority of the incoming non-safe task.
8. The method of clause 7, in which preempting the currently executed non-safe task comprises:
selecting a currently executed safe task having a priority less than the priority of the incoming non-safe task;
posting the currently executed non-safe task in a non-safe tasks waiting queue of a real-time operating system (RTOS) scheduler to provide an available non-safe task PE; and
executing the incoming non-safe task in the available non-safe task PE.
9. The method of any of clauses 1-8, further comprising:
monitoring a safety bit of incoming interrupts;
detecting a safety interrupt in response to the monitoring of the safety bit; and
routing the safety interrupt to a lowest priority safe hardware thread (HWT) in a multi-threaded processor.
10. The method of any of clauses 1-9, in which the PEs comprise hardware threads (HWTs) of a multi-threaded processor.
11. A non-transitory computer-readable medium having program code recorded thereon for temporal freedom from interference (FFI) of safe tasks, program code being executed by a processor and comprising:
program code to write an incoming safe task to a safe task field of a control register;
program code to determine a safe partition and a non-safe partition of processing elements (PEs);
program code to determine priorities of currently executed safe tasks in the safe partition and non-safe tasks in a non-safe partition of the PEs; and
program code to preempt a currently executed safe task if a priority of the currently executed safe task is less than a priority of the incoming safe task.
12. The non-transitory computer-readable medium of clause 11, in which the program code to preempt comprises:
program code to select a currently executed safe task having a priority less than the priority of the incoming safe task;
program code to post the currently executed safe task in a safe tasks waiting queue of a real-time operating system (RTOS) scheduler to provide an available, safe PE; and
program code to execute the incoming safe task in the available, safe PE.
13. The non-transitory computer-readable medium of any of clauses 11 or 12, in which the program code to preempt comprises:
program code to select a currently executed non-safe task having a lowest priority;
program code to post the currently executed non-safe task in a non-safe tasks waiting queue of a real-time operating system (RTOS) scheduler to provide an available non-safe PE;
program code to convert the non-safe PE to a converted safe PE; and
program code to execute the incoming safe task in the converted safe PE.
14. The non-transitory computer-readable medium of clause 13, in which the program code to convert comprises:
program code to determine a PE identification (ID) register associated with the non-safe task PE; and
program code to assert a safety bit of the PE ID register.
15. The non-transitory computer-readable medium of any of clauses 11-14, in which the program code to preempt comprises:
program code to identify a lowest priority safe task executed in the safe partition of the PEs; and
program code to preempt the lowest priority safe task with the incoming safe task.
16. The non-transitory computer-readable medium of claim 15, in which the program code to preempt the lowest priority safe task comprises:
program code to post the lowest priority safe task in a safe tasks waiting queue of a real-time operating system (RTOS) scheduler to provide an available, safe PE; and
program code to execute the incoming safe task in the available, safe PE.
17. The non-transitory computer-readable medium of any of clauses 11-16, further comprising:
program code to write an incoming non-safe task to a non-safe task field of the control register;
program code to determine priorities of currently executed non-safe tasks in the non-safe partition of the PEs; and
program code to preempt a currently executed non-safe task if a priority of the currently executed non-safe task is less than a priority of the incoming non-safe task.
18. The non-transitory computer-readable medium of clause 17, in which the program code to preempt the currently executed non-safe task comprises:
program code to select a currently executed safe task having a priority less than the priority of the incoming non-safe task;
program code to post the currently executed non-safe task in a non-safe tasks waiting queue of a real-time operating system (RTOS) scheduler to provide an available non-safe task PE; and
program code to execute the incoming non-safe task in the available non-safe task PE.
19. The non-transitory computer-readable medium of any of clauses 11-18, further comprising:
program code to monitor a safety bit of incoming interrupts;
program code to detect a safety interrupt in response to the monitoring of the safety bit; and
program code to route the safety interrupt to a lowest priority safe hardware thread (HWT) in a multi-threaded processor.
20. The non-transitory computer-readable medium of any of clauses 11-19, in which the PEs comprise hardware threads (HWTs) of a multi-threaded processor.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable programmable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above, and below may refer to sides of a substrate or electronic device. Moreover, the scope of the present application is not intended to be limited to the particular configurations of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform substantially the same function, or achieve substantially the same result as the corresponding configurations described, may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in random access memory (RAM), flash memory, read-only memory (ROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general-purpose or special-purpose computer. By way of example, and not limitation, such computer-readable media can include random access memory (RAM), read-only memory (ROM), electrically erasable programmable read-only memory (EEPROM), compact disc read-only memory (CD-ROM) or other optical disk storage, magnetic disk storage or other magnetic storage devices, or any other medium that can be used to carry or store specified program code means in the form of instructions or data structures and that can be accessed by a general-purpose or special-purpose computer, or a general-purpose or special-purpose processor. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

The previous description of the present disclosure is provided to enable any person skilled in the art to make or use the disclosure. Various modifications to the present disclosure will be readily apparent to those skilled in the art, and the generic principles defined may be applied to other variations without departing from the spirit or scope of the disclosure. Thus, the present disclosure is not intended to be limited to the examples and designs described but is to be accorded the widest scope consistent with the principles and novel features disclosed.

What is claimed:

1. A method of temporal freedom from interference (FFI) for safe tasks, the method comprising:
writing an incoming safe task to a safe task field of a control register;
determining a safe partition and a non-safe partition of processing elements (PEs);
determining priorities of currently executed safe tasks in the safe partition and non-safe tasks in a non-safe partition of the PEs; and
preempting a currently executed safe task if a priority of the currently executed safe task is less than a priority of the incoming safe task.

2. The method of claim 1, in which preempting comprises:
selecting a currently executed safe task having a priority less than the priority of the incoming safe task;
posting the currently executed safe task in a safe tasks waiting queue of a real-time operating system (RTOS) scheduler to provide an available, safe PE; and
executing the incoming safe task in the available, safe PE.

3. The method of claim 1, in which preempting comprises:
selecting a currently executed non-safe task having a lowest priority;
posting the currently executed non-safe task in a non-safe tasks waiting queue of a real-time operating system (RTOS) scheduler to provide an available non-safe PE;
converting the non-safe PE to a converted safe PE; and
executing the incoming safe task in the converted safe PE.

4. The method of claim 3, in which converting comprises:
determining a PE identification (ID) register associated with the non-safe task PE; and
asserting a safety bit of the PE ID register.

5. The method of claim 1, in which preempting comprises:
identifying a lowest priority safe task executed in the safe partition of the PEs; and
preempting the lowest priority safe task with the incoming safe task.

6. The method of claim 5, in which preempting the lowest priority safe task comprises:
posting the lowest priority safe task in a safe tasks waiting queue of a real-time operating system (RTOS) scheduler to provide an available, safe PE; and
executing the incoming safe task in the available, safe PE.

7. The method of claim 1, further comprising:
writing an incoming non-safe task to a non-safe task field of the control register;
determining priorities of currently executed non-safe tasks in the non-safe partition of the PEs; and
preempting a currently executed non-safe task if a priority of the currently executed non-safe task is less than a priority of the incoming non-safe task.

8. The method of claim 7, in which preempting the currently executed non-safe task comprises:
selecting a currently executed safe task having a priority less than the priority of the incoming non-safe task;
posting the currently executed non-safe task in a non-safe tasks waiting queue of a real-time operating system (RTOS) scheduler to provide an available non-safe task PE; and
executing the incoming non-safe task in the available non-safe task PE.

9. The method of claim 1, further comprising:
monitoring a safety bit of incoming interrupts;
detecting a safety interrupt in response to the monitoring of the safety bit; and
routing the safety interrupt to a lowest priority safe hardware thread (HWT) in a multi-threaded processor.

10. The method of claim 1, in which the PEs comprise hardware threads (HWTs) of a multi-threaded processor.

11. A non-transitory computer-readable medium having program code recorded thereon for temporal freedom from interference (FFI) of safe tasks, program code being executed by a processor and comprising:
program code to write an incoming safe task to a safe task field of a control register;
program code to determine a safe partition and a non-safe partition of processing elements (PEs);
program code to determine priorities of currently executed safe tasks in the safe partition and non-safe tasks in a non-safe partition of the PEs; and
program code to preempt a currently executed safe task if a priority of the currently executed safe task is less than a priority of the incoming safe task.

12. The non-transitory computer-readable medium of claim 11, in which the program code to preempt comprises:
program code to select a currently executed safe task having a priority less than the priority of the incoming safe task;
program code to post the currently executed safe task in a safe tasks waiting queue of a real-time operating system (RTOS) scheduler to provide an available, safe PE; and
program code to execute the incoming safe task in the available, safe PE.

13. The non-transitory computer-readable medium of claim 11, in which the program code to preempt comprises:
program code to select a currently executed non-safe task having a lowest priority;
program code to post the currently executed non-safe task in a non-safe tasks waiting queue of a real-time operating system (RTOS) scheduler to provide an available non-safe PE;
program code to convert the non-safe PE to a converted safe PE; and
program code to execute the incoming safe task in the converted safe PE.

14. The non-transitory computer-readable medium of claim 13, in which the program code to convert comprises:
program code to determine a PE identification (ID) register associated with the non-safe task PE; and
program code to assert a safety bit of the PE ID register.

15. The non-transitory computer-readable medium of claim 11, in which the program code to preempt comprises:
program code to identify a lowest priority safe task executed in the safe partition of the PEs; and
program code to preempt the lowest priority safe task with the incoming safe task.

16. The non-transitory computer-readable medium of claim 15, in which the program code to preempt the lowest priority safe task comprises:
program code to post the lowest priority safe task in a safe tasks waiting queue of a real-time operating system (RTOS) scheduler to provide an available, safe PE; and
program code to execute the incoming safe task in the available, safe PE.

17. The non-transitory computer-readable medium of claim 11, further comprising:
program code to write an incoming non-safe task to a non-safe task field of the control register;
program code to determine priorities of currently executed non-safe tasks in the non-safe partition of the PEs; and
program code to preempt a currently executed non-safe task if a priority of the currently executed non-safe task is less than a priority of the incoming non-safe task.

18. The non-transitory computer-readable medium of claim 17, in which the program code to preempt the currently executed non-safe task comprises:
program code to select a currently executed safe task having a priority less than the priority of the incoming non-safe task;
program code to post the currently executed non-safe task in a non-safe tasks waiting queue of a real-time operating system (RTOS) scheduler to provide an available non-safe task PE; and
program code to execute the incoming non-safe task in the available non-safe task PE.

19. The non-transitory computer-readable medium of claim 11, further comprising:
program code to monitor a safety bit of incoming interrupts;
program code to detect a safety interrupt in response to the monitoring of the safety bit; and
program code to route the safety interrupt to a lowest priority safe hardware thread (HWT) in a multi-threaded processor.

20. The non-transitory computer-readable medium of claim 11, in which the PEs comprise hardware threads (HWTs) of a multi-threaded processor.
